(19) United States
(12) Patent Application Publication
(10) Pub. No.: US 2025/0362555 A1
(43) Pub. Date: Nov. 27, 2025

(54) PRODUCTS MADE WITH VERTICALLY ALIGNED CARBON NANOTUBES FOR MODULATING TRANSMISSION OF LIGHT

(71) Applicant: Lawrence Livermore National Security, LLC, Livermore, CA (US)

(72) Inventors: Alexander Abelson, Fremont, CA (US); Anna Hiszpanski, Pleasanton, CA (US); Sei Jin Park, Santa Clara, CA (US); Philip Malik Jean-Remy, Emeryville, CA (US); Eric Ryan Meshot, Oakland, CA (US); Steven Field Buchsbaum, Livermore, CA (US); Tom Nakotte, Livermore, CA (US)

(21) Appl. No.: 19/192,063

(22) Filed: Apr. 28, 2025

Related U.S. Application Data
(60) Provisional application No. 63/651,601, filed on May 24, 2024.

(51) Int. Cl. G02F 1/155; G02F 1/153; G02F 1/161

(52) U.S. Cl. CPC G02F 1/155; G02F 1/1533; G02F 1/161; G02F 2001/1555

(57) ABSTRACT

An electrochromic device, in accordance with one embodiment, includes a substrate, an optically-active working electrode having aligned carbon nanotubes (ACNTs) coupled to the substrate, a counter electrode, and an electrolyte positioned between the working electrode and the counter electrode. An electrochromic device, in accordance with another embodiment, includes a porous membrane; an optically-active working electrode coupled to a first side of the membrane, the working electrode having aligned carbon nanotubes (ACNTs), a counter electrode coupled to a second side of the membrane that is positioned on an opposite side of the membrane as the first side, and an electrolyte positioned between the working electrode and the counter electrode.

### RELATED APPLICATIONS

This application claims priority to U.S. Provisional Patent Application No. 63/651,601, which is herein incorporated by reference.

This invention was made with Government support under Contract No. DE-AC52-07NA27344 awarded by the United States Department of Energy. The Government has certain rights in the invention.

### FIELD OF THE INVENTION

The present invention relates to carbon nanotubes, and more particularly, this invention relates to products made with vertically aligned carbon nanotubes.

### BACKGROUND

Materials capable of modulating the propagation or emission of light from surfaces, both in the visible and infrared, are of interest for low-power displays (e.g., televisions, tablets, billboards), optical telecommunications, and radiative thermal management in residential, industrial, and commercial buildings. For example, to increase building efficiencies, infrared (IR) radiation entering windows, skylights, etc. should be regulated.

### SUMMARY

An electrochromic device, in accordance with one embodiment, includes a substrate, an optically-active working electrode having aligned carbon nanotubes (ACNTs) coupled to the substrate, a counter electrode, and an electrolyte positioned between the working electrode and the counter electrode.

An electrochromic device, in accordance with another embodiment, includes a porous membrane; an optically-active working electrode coupled to a first side of the membrane, the working electrode having ACNTs, a counter electrode coupled to a second side of the membrane that is positioned on an opposite side of the membrane as the first side, and an electrolyte positioned between the working electrode and the counter electrode.

An apparatus, in accordance with another embodiment, includes at least one electrochromic device comprising an optically-active region having ACNTs, a counter electrode, and an electrolyte positioned between the optically-active region and the counter electrode. The apparatus also includes electrical traces configured to enable addressing the at least one electrochromic device for activating individually-addressable pixels.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIGS. 1A-1B are side views of an illustrative device using VACNTs, in accordance with one embodiment.

FIGS. 2A-2B are side views of an illustrative device using VACNTs, in accordance with one embodiment.

FIGS. 3A-3D are side views of an illustrative device using VACNTs, in accordance with one embodiment.

FIGS. 4A-4F depict a vertically aligned carbon nanotube electrochromic device and related parameters, in accordance with one embodiment.

FIGS. 5A-5C are charts relating to an exemplary infrared response of electrochemically-gated, vertically-aligned carbon nanotubes, in accordance with one embodiment.

FIGS. 6A-6B are charts depicting illustrative time-dependent optical and electronic response of CNT electrochromic devices, in accordance with one embodiment.

FIG. 7 is a flowchart depicting a method for fabricating a plurality of devices on a single substrate, in accordance with one embodiment.

FIG. 8 is a graphical depiction of a method for fabricating a plurality of devices on a single substrate, in accordance with one embodiment.

FIG. 9A is a cross-sectional scanning electron microscopy (SEM) image of a vertically aligned carbon nanotube film at the edge of a Ti/Pt trace, in accordance with one embodiment.

FIG. 9B is a high-magnification image of the metal/carbon nanotube junction of the film of FIG. 9A.

FIG. 10A is a schematic of the transmission line test device, in accordance with one embodiment.

FIG. 10B is a chart showing channel length-dependent resistance data, in accordance with one embodiment.

FIG. 11A is a depiction of a linear resistive test structure used to estimate Ti/Pt trace resistance, in accordance with one embodiment.

FIG. 11B is a SEM image of the Ti/Pt trace after complete processing of the films of the test structure of FIG. 11A.

FIG. 12 is a chart depicting energy-dependent insertion loss and modulation depth for three VACNT film thicknesses, in accordance with one embodiment.

FIG. 13 depicts an exemplary ACNT wall actuator for electromagnetic radiation transmission modulation, in accordance with one embodiment.

FIG. 14 illustrates an example of how current flows through the ACNT structure of FIG. 13.

FIGS. 15A-15C depict an illustrative IR transmission modulation mechanism using angular actuation of an ACNT structure, in accordance with one embodiment.

FIGS. 16A-16B depict an illustrative IR transmission modulation mechanism using linear actuation of an ACNT structure, in accordance with one embodiment.

FIG. 17 is a depiction of linearly actuating ACNT structures arranged in a pixellated array to cover areas larger than individual pixels.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

As used herein, the term “about” denotes an interval of accuracy that promotes the technical effect of the feature in question. In various approaches, the term “about” when combined with a value, refers to ±10% of the reference value.

### Electrochromic Structures made from Vertically Aligned Carbon Nanotube Films

A first aspect of the present invention includes electrochromic devices (devices with optical properties that change in response to an applied voltage) comprised of aligned carbon nanotube films (referred to here as ACNTs), in some cases vertically-aligned carbon nanotube films (referred to here as VACNTs), which show strong voltage-dependent transmission of near- and/or shortwave-infrared radiation. Devices described herein, according to various approaches, may be fabricated into large-area windows that modulate the flow of infrared radiation into buildings, may be integrated as micro-arrays into optical computing chips to modulate or route the flow of infrared optical communication signals, etc. Furthermore, the novel device designs may also prove useful for modulating the propagation and/or emission of mid-and/or far-infrared electromagnetic radiation. More detailed information is provided below.

In one approach, films of ACNTs and/or VACNTs are used to develop scalable, rigid or flexible devices that, under an applied electrical bias, can modulate the transmission, absorption, reflection, and/or emission of visible and/or infrared radiation. These materials and devices may be used for a wide variety of technological applications. In particularly preferred approaches, these devices offer fine control over the wavelength range(s) and degree of optical modulation.

Previous work on carbon nanotube-based devices has explored and demonstrated the effects of electrical bias or electrolytic gating on the absorption/transmission/emission of infrared radiation. Common to these prior demonstrations is the use of mats/sheets consisting of randomly-oriented, typically 2-dimensional (flat-lying) networks of carbon nanotubes. The primary disadvantage of such prior attempts is the poor control over the orientation of carbon nanotubes, which leads to poor control over the overall optical response of the device.

The inventors have discovered that by unifying the orientation of the nanotube populations, finer control may be exerted over the optical properties of the device. To the inventors' knowledge, electrochromic devices containing ACNTs, especially VACNTs, have not been conceived of, published on, or patented.

The alignment of carbon nanotubes in the devices, according to various approaches, leads to unique photophysics compared to randomly-oriented 2 dimensional network carbon nanotube electrochromic devices. The demonstrated electrochromic performance (namely, a proven change in transmittance at ˜1.7 micrometers of up to 47% for VACNTs—see “Experimental” section below) has not been attained with device configurations other than those disclosed herein. Controlling the transmission of light within this optical wavelength band is ideal for dynamic windows that help regulate the temperature inside of buildings.

In some general approaches, an electrochromic device includes at least some of the following elements 1)-4), described below.
1) An optically-active region comprising an optically-active working electrode with ACNTs, and preferably VACNTs as providing the best optical performance. This component has optical properties that undergo changes upon electrical biasing of the device, thereby affecting transmission of infrared (IR) light therethrough, e.g., by absorbing more or less of the IR light. A unique feature of these devices is that the carbon nanotubes are aligned, and in preferred embodiments, vertically aligned.

In some approaches, carbon nanotubes are considered aligned when the carbon nanotubes are substantially aligned with one another along their longitudinal axes. Substantial alignment may include minor variations, such as bends or waviness in the nanotubes in the array. Preferably, such bends or waves vary no more than 20 degrees from a common direction, e.g., a predominant direction along which the longitudinal axes are aligned.

The longitudinal axes of VACNTs are primarily oriented about 90 degrees from the plane of the underlying substrate. In other approaches of ACNTs that are not VACNTs, the longitudinal axes may be, on average, oriented at an angle of less than 81 degrees from the plane of the substrate. For instance, the longitudinal axes of carbon nanotubes may generally extend along a line oriented at an angle in a range of 45 to 81 degrees from the plane of the substrate, preferably from 60 to 81 degrees from the plane of the substrate, and ideally from 75 to 91 degrees from the plane of the substrate. Moreover, as noted below, growth processing may be performed to flatten or otherwise reorient the ACNTs toward an alignment parallel to the plane of the substrate, though axial alignment of the ACNTs should be retained.

Note that in some approaches, the ACNTs may bend along the lengths of their longitudinal axes, e.g., the ACNTs may include segments defined by such bends. For example, lower portions of the carbon nanotubes may be substantially aligned with one another but oriented at an angle of less than 180 degrees from middle portions of the carbon nanotubes, where the middle portions of the ACNTs are also substantially aligned with one another.

In some approaches, carbon nanotubes are considered aligned when at least 50% of the lengths of the longitudinal axes of most (>50%) of the carbon nanotubes in an array, are aligned with one another, more preferably when at least 75% of the lengths of most of the carbon nanotubes in an array are aligned with one another, and ideally when at least 90% of the lengths of most of the carbon nanotubes in an array are aligned with one another.

In some approaches, carbon nanotubes are considered aligned when most of the carbon nanotubes in a group of adjacent carbon nanotubes has at least half (by length) of their longitudinal axes substantially aligned along a common direction associated with that group. Where there are several groups, each group may have a different common direction associated therewith, e.g., the common direction of different groups may be angled from one another, e.g., by greater than 0 degrees up to about 45 degrees. Note that a group should not have a significant number (e.g., >10%) of interspersed carbon nanotubes with longitudinal axes that are not aligned. Moreover, an array of carbon nanotubes having longitudinal axes of random orientation should not be considered to have several such groups.

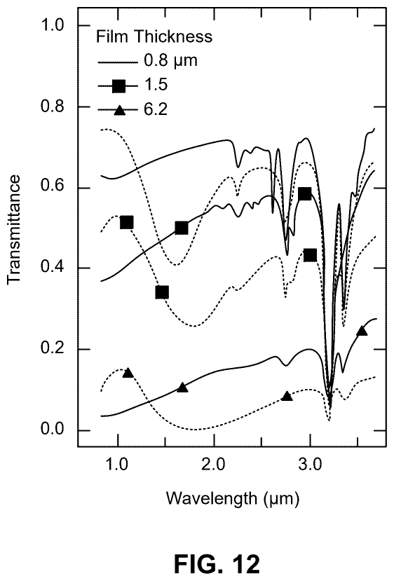

The average length of the ACNTs and/or VACNTs may be any desired length. In preferred approaches, the average lengths of the ACNTs and/or VACNTs fall within a range of about 0.2 microns to about 200 microns, more preferably about 0.5 microns to about 100 microns, but could be longer in other approaches (e.g., up to several centimeters). Note that shorter lengths generally correspond to increasing visible transparency, while longer lengths result in increasing opacity. Moreover, shorter average ACNT and/or VACNT lengths tend to affect near-IR (short wavelength infrared) e.g., in the about 1.7 micron to about 3 micron range. Longer average VACNT lengths, e.g., where opacity to visible light is observed, enable modulation of longer IR wavelengths, e.g., in the about 3 micron to about 12 micron range. If the ACNTs and/or VACNTs are long enough, no light will pass through at all, but the absorbance and reflectance of the ACNT and/or VACNT field may be adjusted to provide an effect. For example, longer lengths may be used for heat dissipation applications. See FIG. 12 and related discussion in the Experimental section below for examples of how VACNT length affects transmittance.

The fundamental operation of the device does not change significantly with changes in average CNT diameter, though absorptive properties are affected by CNT diameter, where lower diameter CNTs more prevalently affect shorter IR wavelengths. Accordingly, the average length and average diameter of the CNTs may be chosen according to the desired wavelength to be modulated. In other words, the average length and average diameter are variables that may be tuned to affect a desired IR wavelength range. Illustrative average longitudinal lengths are provided above. In some approaches, average diameters of the CNTs may be in a range of sub-nanometer to about 30 nanometers, but could be higher in some approaches. In another approach, the average diameters of the CNTs is in a range of about 1 nanometer to about 30 nanometers.

In some approaches, post-ACNT and/or post-VACNT growth processing may be performed to flatten or otherwise reorient the CNTs, though axial alignment of the CNTs should be retained. Accordingly, any of the approaches described herein may use flattened and/or slanted ACNTs, as well as or instead of ACNTs having axes oriented closer to perpendicular to the substrate.

The optically-active region may include a single electrified area of ACNTs and/or VACNTs spanning arbitrarily large geometric areas limited only by the method of ACNT and/or VACNT growth. In some approaches, ACNT and/or VACNT forest area average width on round wafers may be up to about 6 inches (or larger on larger wafers). In other approaches, devices are created using ACNTs and/or VACNTs made via roll-to-roll fabrication processes. In individual wafers, sections can be co-assembled to make larger windows spanning arbitrary distances. Similarly, a plurality of the electrochromic devices may be assembled into an array, where each of the electrochromic devices provides an individually-addressable pixel.

The optically-active region of a particular electrochromic device may also be subdivided into individually-addressable pixels, controllable via known techniques adapted for use with the apparatus according to the teachings herein. The size of each pixel may reach lateral dimensions as small as ˜100 nm per side, e.g., about 100 nm to about 500 nm along one side of each pixel. In turn, wafers/substrates containing an arbitrary number of pixels may be co-assembled to form larger pixel arrays spanning arbitrary distances, where the optically-active region of each of the electrochromic devices in the array is subdivided into the individually-addressable pixels.

Electrical traces of conventional construction may be provided in a configuration that enable addressing of each pixel for selectively activating the individually-addressable pixels. Various embodiments may include multiple traces to address individual sections (pixels) of a single electrochromic device, traces to address each electrochromic device in an array, or a combination thereof.

A controller may be coupled to said traces, and configured to address the electrochromic device(s) for activating the individually-addressable pixels within each device, of a particular device in a larger array, or both.
2) A large-area counter electrode (may be optically active or optically inactive) made of ACNTs and/or VACNTs, carbon nanotubes, graphene, metal, or other, preferably high surface area, conductive material.
3) An electrolyte, typically an ionic liquid, but also can include aqueous or non-aqueous electrolytes. Almost any ionic liquid may be used, and generally across a large range of viscosities. For example, an ionic gel or fluid with lower viscosity may be used. More viscous electrolytes may be preferable for window applications. The electrolyte is preferably chosen based on its optical and electrochemical properties to maximize transparency and/or opacity in the relevant energy ranges, and/or to maximize the range of electrochemical stability. The electrolyte may be mixed with electrochemically active species (e.g., ions or neutral compounds) that can be used to dope the ACNTs and/or VACNTs.
4) In some approaches, the device may contain a third electrode which serves as an electrochemical reference electrode. The reference electrode may be constructed of any conductive material, preferably Pt or another metal.

The components noted above may be integrated into a device in which the electrolyte physically contacts (wets) the other components, thus forming an electrochemical cell.

A control circuit, configured to control the voltage and/or level of current applied to the electrodes, may be used to adjust the optical properties of the ACNTs and/or VACNTs in any desired way. For example, the control circuit may be configured to create voltages and/or currents that adjust the optical properties of the ACNTs and/or VACNTs in predefined manner, e.g., to switch the ACNTs from IR absorptive to IR transmissive via change in the voltage or current applied thereto. The control circuit, which may be or include a power source, may create a voltage differential between the electrodes with an approximate value in a range of −5 V to 5 V, more preferably in a range of −1 V to 1 V. In other approaches, higher or lower voltage differentials may be used.

Various embodiments of the device were conceived of and/or constructed. Several illustrative approaches are presented below, by way of example only.

### Exemplary Embodiment 1

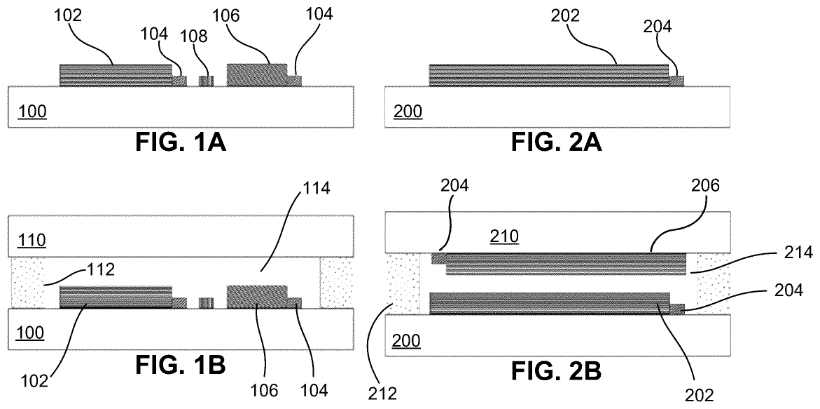

FIGS. 1A and 1B are side views of an illustrative device using VACNTs, in accordance with one approach. As an option, the present device may be implemented in conjunction with features from any other approach listed herein, such as those described with reference to the other Figures. Of course, however, such device and others presented herein may be used in various applications and/or in permutations which may or may not be specifically described in the illustrative approaches listed herein. Further, the device presented herein may be used in any desired environment.

Note also that the visual texturing applied to the various components of the drawings is not meant to imply a particular structure or orientation, but rather has been added to assist in differentiating the individual components.

Note further that although this and other examples are described as using VACNTs, as preferred for obtaining the best results, similar embodiments may be constructed using ACNTs having any orientation relative to the substrate.

A solid (opaque to visible and/or IR energy/light, semi-opaque, optically transparent, IR transparent, etc.) substrate 100 is patterned with VACNTs 102, e.g., via growth thereon or coupling of the VACNTs thereto.

The longitudinal axes of the VACNTs are generally aligned perpendicular to the plane of the substrate (generally vertically, e.g., as in FIGS. 1A-1B.

In some approaches in which the VACNTs are grown on the substrate. In such embodiments, the substrate may be of any conventional material upon which VACNTs may be grown or coupled. Exemplary substrate materials include sapphire, glass, silicon, quartz, fused silica, Si, ZnSe, mica, SiC, etc.

In other approaches where a forest of VACNTs is formed elsewhere and adhered to the substrate, the substrate may be of any suitable conventional material, including those listed above.

Conductive electrode traces 104 are also coupled to the substrate. The traces may be patterned, printed, adhered, or otherwise added to the substrate, preferably prior to formation or addition of the VACNTs. Conventional trace formation techniques may be used. The electrode traces in this example are of metal such as Pt or TiN, though any other suitable material may be used.

Note also that the substrate may be insulating or conductive in various approaches. For example, substrates of sapphire, glass, or silicon fall on the more insulating end of the spectrum. In another approach, VACNTs are grown onto metal foils, where the foils themselves are very conductive. In that case, added electrodes may not be needed.

A counter electrode 106 composed of a conductive material, preferably VACNTs or some other high surface-area material, is present adjacent to the working electrode and contacted by one of the conductive electrode traces 104.

In some approaches, an optional reference electrode 108 composed of any suitable conductive material such as Pt or TiN is present adjacent to the working and counter electrodes.

A second substrate 110 may be coupled to the substrate 100, e.g., adhered thereto using any conventional coupling material or coupling construction. In one approach, the coupling material is a conventional adhesive 112 containing spacer material such as glass spacer beads.

The second substrate 110 may be opaque, semi-opaque, optically transparent, IR transparent, etc. The second substrate may have similar construction as the first substrate, may be constructed of a different material, or may be a conventional substrate.

The device stack is then infilled with an electrolyte 114 and preferably sealed to enclose and retain the electrolyte. The electrolyte is thus positioned between the working electrode and the counter electrode, and preferably the electrolyte infills interstices between the ACNTs of the electrode(s).

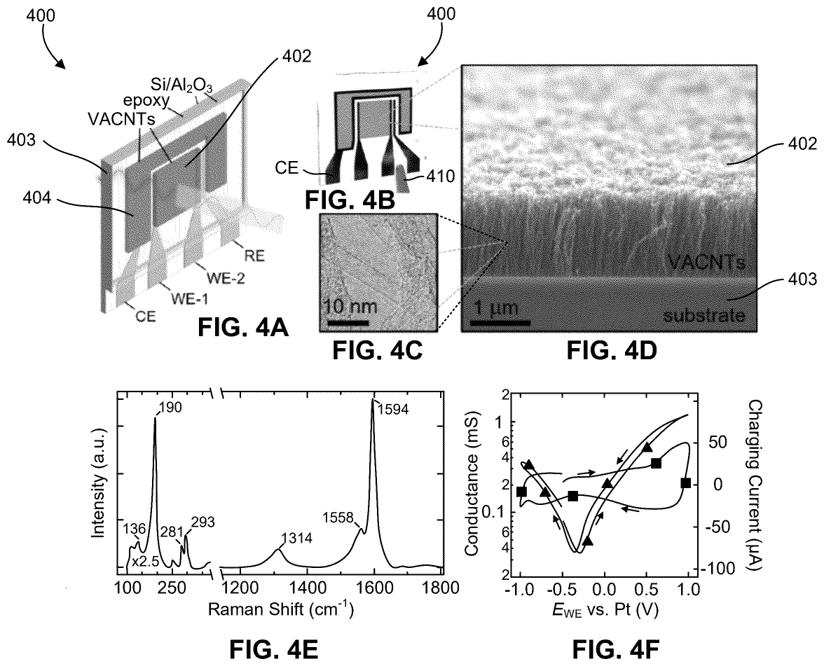

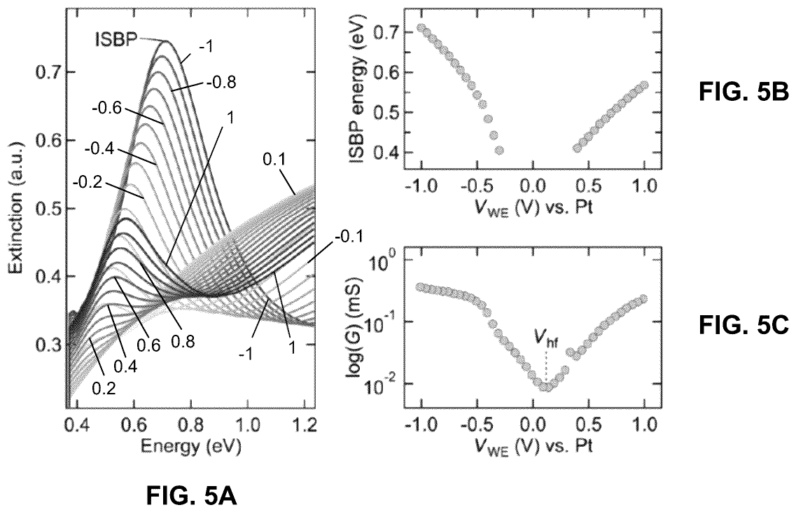

In use, the device may be placed in the optical path of visible or infrared radiation and electrically biased with a conventional voltage source or known potentiostat to alter the transmission of near-and shortwave-infrared radiation through the device. For exemplary images and structural, electronic, and electrochromic characteristics of Exemplary Embodiment 1, see FIGS. 4A-5C.

### Exemplary Embodiment 2

FIGS. 2A-2B are side views of an illustrative device, in accordance with one approach. As an option, the present device may be implemented in conjunction with features from any other approach listed herein, such as those described with reference to the other Figures. Of course, however, such device and others presented herein may be used in various applications and/or in permutations which may or may not be specifically described in the illustrative approaches listed herein. Further, the device presented herein may be used in any desired environment.

Components shown in FIGS. 2A-2B may have similar construction characteristics and fabrication methodologies as similar components in FIGS. 1A-1B.

A solid (opaque, semi-opaque, optically transparent, IR transparent, etc.) substrate 200 is patterned with VACNTs 202 and conductive electrode traces 204. A counter electrode 206, e.g., composed of VACNTs or some other high surface-area material, is patterned on an upper substrate 210. The two substrates are inverted such that the deposited materials face one another. The two substrates are preferably coupled, e.g., using any conventional coupling material. In one approach, the coupling is effected using an adhesive-containing spacer material 212 such as an adhesive with glass spacer beads. In some approaches, a porous spacer membrane of known type may be placed in between the top counter electrode and bottom VACNT film. The device stack is then infilled with an electrolyte 214 and preferably sealed. The device may be placed in the optical path of visible or infrared radiation.

### Exemplary Embodiment 3

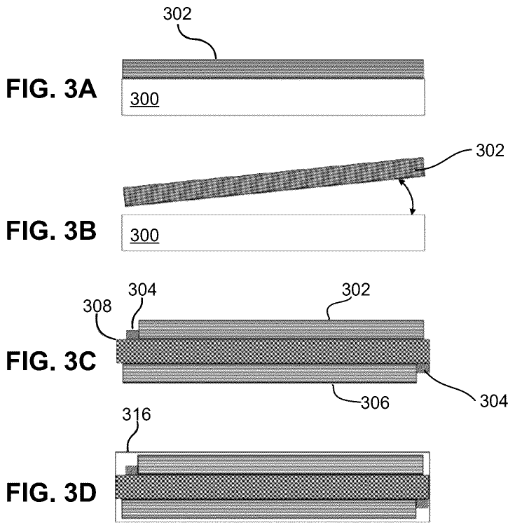

FIGS. 3A-3D are side views of an illustrative device, in accordance with one approach. As an option, the present device may be implemented in conjunction with features from any other approach listed herein, such as those described with reference to the other Figures. Of course, however, such device and others presented herein may be used in various applications and/or in permutations which may or may not be specifically described in the illustrative approaches listed herein. Further, the device presented herein may be used in any desired environment.

Components shown in FIGS. 3A-3D may have similar construction characteristics and fabrication methodologies as similar components in FIGS. 1A-1B and 2A-2B.

In the example of FIGS. 3A-3D, a solid substrate 300 is coated with VACNTs 302. The VACNTs are subsequently delaminated, e.g., via conventional vapor, liquid or gas phase process, as shown in FIG. 3B. Referring to FIG. 3C, the VACNT film is deposited onto a non-electrically conductive porous membrane 308. Alternatively, a porous non-electrically conductive layer or layers may be laminated on the membrane, thereby enabling use of an electrically conductive membrane. Electrically conductive traces 304 of any desired composition may be coupled to (e.g., patterned onto) the membrane, and/or traces may be added following VACNT deposition through any conventional process, e.g., a vapor or liquid phase process. The first VACNT film and electrode thus form an optically-active working electrode. A second VACNT film or other high surface-area conductive media is deposited on the backside of the non-conductive porous membrane as a counter electrode 306, such that the membrane sits in between the two films (see FIG. 3C). Electrolyte (not pictured) is wetted into the device stack, thereby being positioned in the membrane between the electrodes, and preferably infilling at least a portion of, and preferably substantially all of, the interstices between the VACNTs in the working electrode, and preferably in each film.

In some approaches, an encapsulant 316 of any suitable type may be deposited or laminated on the device exterior. Illustrative encapsulants include polymeric films deposited from the vapor phase, lamination sheets, inorganic materials grown from vapor phase, etc. In some approaches, electrolyte may be added following encapsulation.

In the three Exemplary Embodiments described above, the respective device is connected via two or three electrodes to a control circuit, e.g., a controlling voltage source and/or current source of known type. Device performance may be evaluated using a spectrophotometer operating in transmission or reflection mode, or wavelength-appropriate camera. During such measurements, the device may be placed in the optical path of the spectrophotometer or camera and subjected to application of voltage and/or current during measurement.

In an application such as dynamic, infrared-blocking windows, a large-area device spanning the entire window may be connected to one or several voltage/current sources and be manipulated to control the transmission, absorption, reflection, and/or emission of infrared and/or visible radiation through the window. Such large-area device may include a large, contiguous array of ACNTs and/or VACNTs, a plurality of arrays of ACNTs and/or VACNTs with corresponding electrodes, etc.

In some approaches, the electrodes and/or VACNT arrays are constructed and/or configured to provide discretely addressable sections of the overall device. For example, a top half of a window may be independently controllable relative to the bottom half. Thus, in one mode of operation, the top half may be set, via a controller, to reduce or block IR radiation passing therethrough while the lower half is set to allow IR radiation to pass therethrough. In another mode of operation, the bottom half may be set to reduce transparency to visible light, while the top half is set to maximum transparency.

In a device scheme containing numerous addressable pixels (sections), each pixel may be addressed through a multiplexed voltage/current supply of conventional type.

In operation, application of a voltage to an electrochemical device as described herein, such as one of the electrochemical device schemes (see FIGS. 1B, 2B, 3C, 3D), leads to electrochemical gating of the ACNT and/or VACNT film. Gating occurs through the formation and/or modulation of an electric double layer at the CNT interface and results in a shift of the Fermi level within the ACNTs and/or VACNTs. Shifts in the Fermi level lead to changes in the occupation of electronic states and in the measurable electronic properties of the ACNTs and/or VACNTs. These changes, in turn, lead to measurable changes in the optical transmittance, absorptance, and/or reflectance of the ACNTs and/or VACNTs.

At present, the inventors have conducted experiments to demonstrate that VACNTs exhibit a pronounced and reversible absorption peak at a wavelength of ˜1.7 micrometers which is induced upon electrical biasing. These results are described below in the section entitled “Experimental.”

In the device schemes described and implied herein, the counter electrode serves to balance the charge on the optically-active working electrode. The wavelengths exhibiting changes in transmittance, absorptance, and/or reflectance upon electrical biasing are determined by a variety of intrinsic and extrinsic device/material parameters, including film thickness, carbon nanotube diameter, carbon nanotube orientation, defect density, electrolyte, and substrate choice.

While significant changes in the near infrared (1-3 micrometers) have been achieved by the inventors, it is believed that changes in the aforementioned device parameters allow manipulation of the optical transmittance, absorptance, and/or reflectance at other wavelengths across the visible and/or infrared portions of the electromagnetic spectrum.

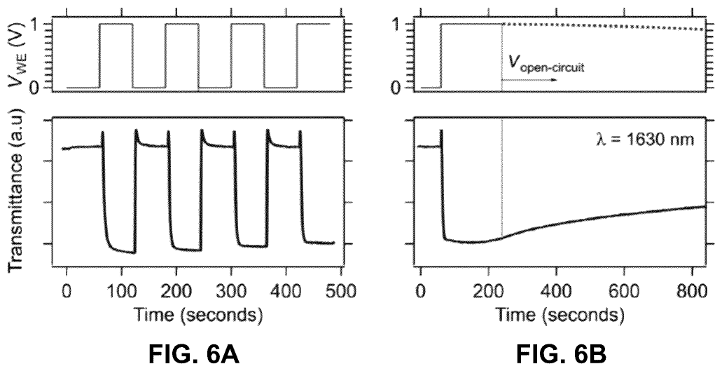

One important operational feature of devices, according to various approaches, is that they can be operated actively or passively (see FIGS. 6A-6B).

In active operation, an electrical bias is continuously applied.

In passive operation, the device state is set with a brief application of voltage. After some time, the device is swiftly placed into an open-circuit configuration, effectively “freezing in” the optical state of the device. The optical state remains substantially fixed until the working and counter electrode are electrically shunted, allowing the charge to dissipate. In this way, the device may behave as a pseudocapacitor, allowing for the accumulation of weakly bound charges at the VACNT/electrolyte interface. Passive operation of an illustrative device is demonstrated in the “Experimental” section.

The use of ACNTs and/or VACNTs as electrochromic materials is entirely novel. Due to the unique orientation-dependent photophysics of carbon nanotubes, coupled with the non-trivial methods of device fabrication and assembly, the completed devices enabled by the description made herein, including the schemes of FIGS. 1A-3D, represent aspects of a novel invention.

The devices presented in FIGS. 1A-3D and their equivalents use elements arranged in a unique and novel configuration. For example, the use of ACNTs or VACNTs as an electrochromic material is previously unknown. The design of devices incorporating ACNTs and/or VACNTs requires both non-trivial device fabrication processes, and photophysics, which distinguishes it from other carbon nanotube-based electrochromic devices. These distinguishing characteristics would not be considered obvious or common knowledge to those of ordinary skill in the relevant art.

FIGS. 4A-4F depict a VACNT electrochromic device and related parameters, in accordance with an illustrative embodiment. As an option, the present device may be implemented in conjunction with features from any other approach listed herein, such as those described with reference to the other Figures. Of course, however, such device and others presented herein may be used in various applications and/or in permutations which may or may not be specifically described in the illustrative approaches listed herein. Further, the device presented herein may be used in any desired environment.

FIG. 4A is a schematic of the exemplary device 400. ACNTs, preferably VACNTs 402, patterned at the center of the substrate 403 of the device form the optically-active working electrode region that is electrically addressed by two working electrodes (WE-1 and WE-2), in this example made of a conductive material such as Pt. The substrate comprises Si with a catalyst of Al₂O₃ in this example. A counter electrode (CE) is positioned adjacent to the central region, and is made of a conductive material. The CE shown encircles another region of VACNTs 404, though a material with a relatively higher surface area (than a bare trace) may be used, and/or the CE may not completely encircle the second region of VACNTs. Referring again to FIG. 4A, between WE-2 and CE is a thin conductive trace, in this example of Ti/Pt, that functions as the reference electrode (RE).

In a more basic configuration, only WE-1 and CE are present; RE and WE-2are not used in the basic configuration. In use, a voltage differential is applied to WE-1 and CE to alter the IR absorptive properties of the VACNTs (both fields of VACNTs). If present, WE-2 and/or RE may be used to collect diagnostic information from the device. For example, WE-2 may be used to create a small voltage differential between WE-1 and WE-2.

Electrolyte fluid is present in the cell.

Conventional electrochemical control techniques may be adapted for use herein to set the proper potential differences in the device on the various electrodes to achieve a desired reflectance, absorbance, and/or transmittance, in a manner that would become apparent to one skilled in the art after reading the present disclosure.

The device substrate may be coupled to a thin capping sheet (e.g., an upper substrate, not shown) of the same or different composition to form the cell via any conventional technique. In a preferred embodiment, a bond is formed using a thin strip of epoxy/spacer bead slurry deposited along the edges of the device to provide resilience to the device, seal in the electrolyte, etc.

FIG. 4B is an optical image of a completed device 400 created during development of the present invention. A human finger 410 is present for reference. As shown, the CE trace encircles the horseshoe-shaped VACNT field, and preferably extends under the VACNTs at least slightly.

FIG. 4C is a cross-section SEM image of an as-made VACNT forest on Si. The sample was cleaved such that the viewpoint looks at the center of the optically-active region of the device.

FIG. 4D is a representative TEM image of a ˜4.0 nm diameter CNT.

FIG. 4E depicts Raman spectra of a dry CNT forest grown on sapphire. Peaks at 1594 and 1558 cm⁻¹ originate from G-band phonon modes. The peak at 1314 arises from carbonaceous impurities/defects. Peaks below 300 cm⁻¹ are CNT radial breathing modes. Note the split axis. The spectrum on the left portion of the graph is multiplied by 2.5.

FIG. 4F depicts electrochemical measurement of a completed device showing both the through-plane CNT conductance (left, triangles) and charging current (right, squares). The working electrode sweep rate was 5 mV s⁻¹ and the potential offset between the two working electrodes was 60 mV.

FIG. 5A depicts optical extinction spectra of a VACNT film for V_{WE} at twenty different voltages from −1 V to 1 V relative to the Pt reference electrode of the device of FIG. 4B. The voltages V_{WE} corresponding to various lines (e.g., −1, −0.8, −0.6 . . . 0.8, 1) are labeled within the chart in association with the corresponding line. The broad, prominent peak is assigned to the intersubband plasmon absorption. V_{WE} was held for 120 seconds prior to each optical measurement. Spectra were baseline corrected to eliminate peaks from the ionic liquid.

FIG. 5B depicts intersubband plasmon (ISBP) peak energy vs. V_{WE} extracted from the data in FIG. 5A. The peak position shifts with gating potential.

FIG. 5C is a logarithm of the VACNT film conductance measured simultaneously to the optical measurements. The conductance minimum corresponds to the half-filling potential V_{hf}. For this particular film, V_{hf}=0.12 V. The VACNT film in this device was 1.5 μm thick with d_{CNT}=2.6±0.7 nm (Type 1 catalyst described in Experimental section).

FIG. 6A depicts the transient optical response at λ=1630 nm upon switching of V_{WE} between 0 V and 1 V in the device of FIG. 4B. The characteristic on and off times are 6 and 1 seconds, respectively. In this experiment, IR light was directed at the device, and measurements were taken of the transmittance while at the two different voltage states. As shown, when the device is set to 0 V, the transmittance through the VACNT film is high. When V_{WE} is set to 1, the transmittance through the VACNT film drops. Note that the voltage figure is relative to RE (0 V and 1 V difference between the voltages on RE and WE-1). RE was fixed at a predetermined potential. A potentiostat was used to adjust the voltage on CE to maintain the desired V difference between WE-1 and RE.

Note that the VACNTs may be intrinsic or doped carbon nanotubes. In both cases, the change in applied potential acts to electrochemically dope (shift the Fermi level of), the VACNTs in a reversible manner.

FIG. 6B depicts electrical charging and optical state memory upon switching the device to an open-circuit condition. After ˜30 seconds, the device is switched from a potential of 0 V to 1 V, held at 1 V for 3 minutes, then set into an open-circuit configuration on the potentiostat. The top panels show the applied (solid) and measured (dashed) circuit potentials.

FIG. 6B demonstrates that, in some approaches, removing power (e.g., unplugging the circuit) does not result in an immediate return to a high transmittance state; rather, the voltage remains relatively constant for a fairly long time and the absorptive state exhibits a similarly slow decay. This feature provides a great advantage in terms of power savings, e.g., the high absorption state may be achieved quickly via application of the voltage differential, and then power may be removed until the transmission, absorption, reflection, and/or emission reaches a predefined level, upon which the voltage differential may again be applied for a short duration, and the cycle repeated.

More information about FIGS. 6A-6B is provided below in the Experimental section.

The devices described herein may be fabricated following the teachings herein, using any combination of fabrication steps that would become apparent to one skilled in the art after reading the present disclosure. Such fabrication steps may be adapted from conventional processes for creating CNTs, similar layers, structures, etc.

In one exemplary approach for fabricating a portion of a device, conductive traces are patterned onto a substrate of any suitable type. Exemplary substrate materials and trace materials are listed elsewhere herein. In some approaches, the traces may serve separately as bottom contacts for a VACNT film and as a quasi-reference electrode. A catalyst is deposited above the substrate in areas where the VACNTs are to be grown. The catalyst may be deposited by electron beam evaporation or other known technique. At least one VACNT film is grown, e.g., by chemical vapor deposition or other known technique, onto the metallized and catalyst-patterned substrates. An upper substate is positioned above the substrate, thereby forming a cell. The cell is infilled with an ionic fluid, e.g., as described elsewhere herein, and the cell is sealed, e.g., with a barrier such as a sealant.

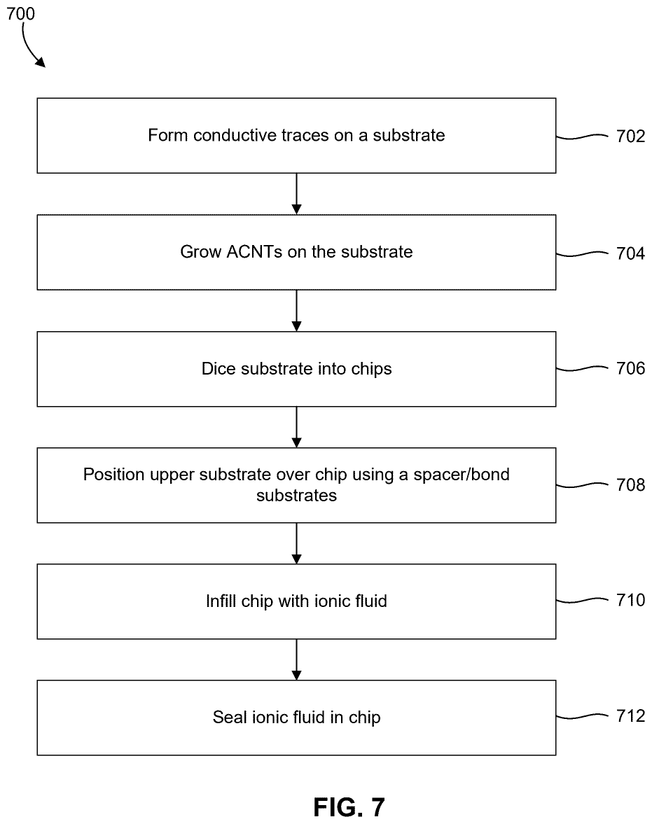

FIG. 7 graphically depicts a method 700 for fabricating a plurality of devices on a single substrate, in accordance with one embodiment. As an option, the present method 700 may be implemented to construct structures, devices, etc. such as those shown in the other FIGS. described herein. Of course, however, this method 700 and others presented herein may be used to form structures for a wide variety of devices and/or purposes which may or may not be related to the illustrative embodiments listed herein. Further, the methods presented herein may be carried out in any desired environment. Moreover, more or less operations than those shown in FIG. 7 may be included in method 700, according to various embodiments. It should also be noted that any of the aforementioned features may be used in any of the embodiments described in accordance with the various methods.

As shown in FIG. 7, a plurality of devices if a type similar to that shown in FIG. 4A may be fabricated on a single substrate. In step 702, conductive traces are formed, e.g., photopatterned, onto a substrate. The substrate may be a wafer. The conductive traces may form part of the working electrode and the counter electrode. In step 704, ACNTs, preferably VACNTs, are grown on the substrate. In step 706, the wafer substrate may be diced into chips to create discrete devices. In step 708, a spacer (e.g., spacer beads) may be used to support an overlying upper substrate over each chip, enabling an ionic fluid to be infilled between the substrate and upper substrate. If the spacer includes an adhesive, e.g., an epoxy, the upper and lower substrates are bonded together. The bonding of step 708 preferably occurs prior to infilling the device with ionic liquid in step 710. In step 712, a barrier such as an adhesive sealant (e.g., epoxy) may be applied to thereby seal the ionic fluid between the substrates. The spacer may remain or may be removed. In an alternate approach, a solid barrier may be added along and/or between the edges of the substrates to seal the ionic fluid in the cell. In yet another alternative approach, the upper substrate may have a peripheral lip that extends from the plane of the upper substrate and engages the lower substrate, with or without intervening material to effect a seal therebetween.

### Experimental

The following section describes experimentation conducted by the inventors. This information has been provided by way of example only and without limitation on the scope of the present invention.

Electrochromic devices were fabricated, each having three primary electrical elements: an electrochromic VACNT working electrode, a high surface area VACNT counter electrode, and a Pt quasi-reference electrode, as shown in FIGS. 4A and 4B.

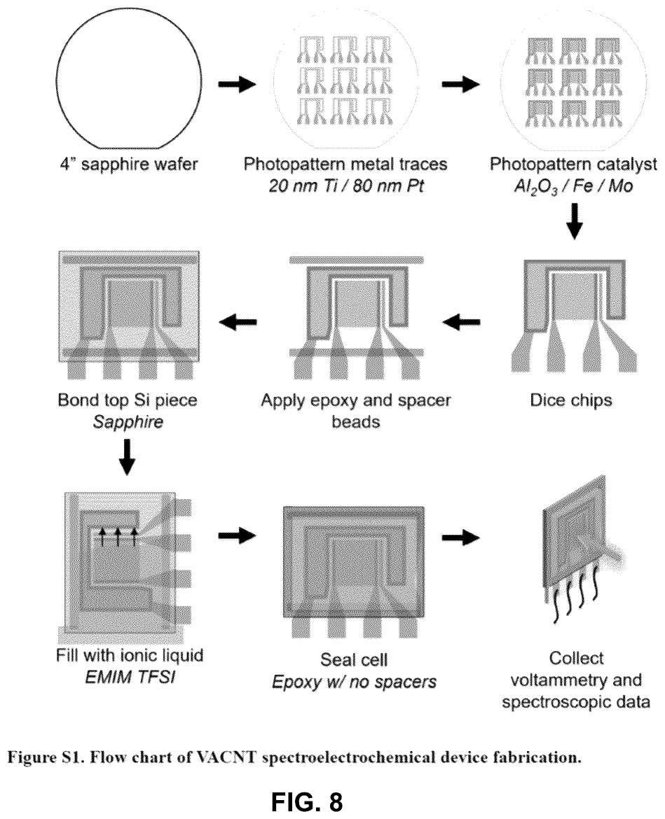

A detailed description of the fabrication process is presented in FIG. 8. First, Ti/Pt traces were patterned onto sapphire substrates; these traces serve separately as bottom contacts for the VACNT film and as a reference electrode. Next, catalyst stacks containing 40 nm of alumina and sub-nm films of Fe and Mo were deposited by electron beam evaporation. VACNT films were subsequently grown by chemical vapor deposition onto the metallized and catalyst-patterned sapphire substrates. In agreement with previous work from the inventors' laboratory, these VACNT films are dense, uniform, continuous, and feature strong vertical alignment of the individual CNTs (FIG. 4C). To prepare films with two distinct CNT sizes the composition of the catalyst stacks was varied, yielding CNTs with diameters of 2.6±0.7 nm (Type 1) and 5.6±1.2 nm (Type 2). Raman spectra (FIG. 4E) reveal two noteworthy insights about the CNT structure and composition. First, the G-band resonance at 1594 cm⁻¹ has an integrated peak area ˜5× larger than the D-band at 1315 cm⁻¹, indicating a relatively high degree of graphitization. Second, well-defined radial breathing modes (at frequencies below 300 cm⁻¹) indicates the presence of single-walled CNTs. Transmission electron microscopy further confirms their nearly pure single-walled character. Finally, device substrates were epoxied to bare sapphire substrates, then vacuum infiltrated with the IL [emim][tfsi] to yield the complete electrochromic devices (FIGS. 4A and 4B).

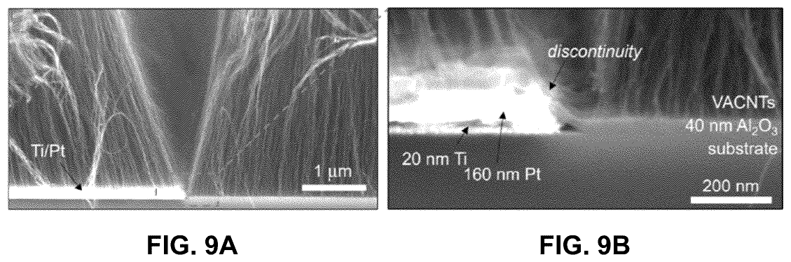

Prior to optical measurements, the basic electronic behavior of the devices was assessed. Despite a 40 nm insulating alumina layer between the CNTs and the Pt bottom contacts, the contact resistance is surprisingly low. High-resolution imaging of the CNT/Pt interface shows small fractures in the alumina layer which is believed to offer shunt pathways for the CNTs to directly contact the metal traces (FIGS. 9A-9B). Note that in FIG. 9B, clearly visible are the Si substrate, 40 nm Al₂O₃ catalyst buffer layer, 20 nm Ti and 160 nm of Pt. Denoted in the mage is the discontinuity in the Al₂O₃ layer at the edge of the metal trace.

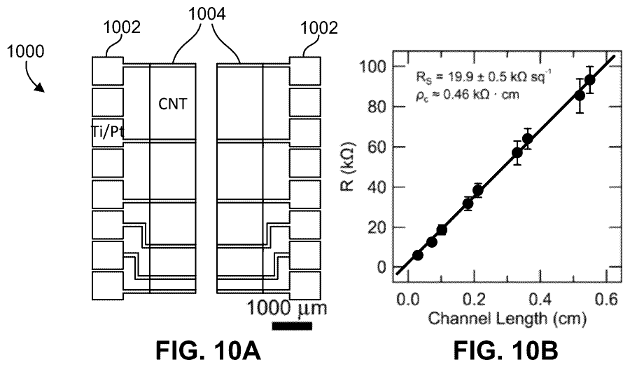

VACNT transmission line structures yielded a specific contact resistivity of ˜0.5 kΩ·cm and a VACNT sheet resistance of ˜20 kΩ·sq⁻¹ (FIGS. 10A-10B), which corresponds to contact resistance of 302 Ω and film resistance of 17.3 kΩ in a typical device. Particularly, FIG. 10A is a schematic of the transmission line test device 1000, showing the Ti/Pt trace 1002 and the VACNTs 1004. The scale bar is 1000 μm. FIG. 10B is a chart showing channel length-dependent resistance data. The slope of the fit (R/I) was multiplied by the channel width (0.12 cm) to arrive at the sheet resistance (Rₛ). The y-intercept is the contact resistance (R_{C}). The specific contact resistivity is the contact resistance multiplied by the total length of the metal-CNT contact (0.24 cm). Error bars represent the standard deviation calculated from six replicates. These measurements were performed on a VACNT film grown for 12 seconds using catalyst Type 1. The film was in a dry state (no ionic liquid).

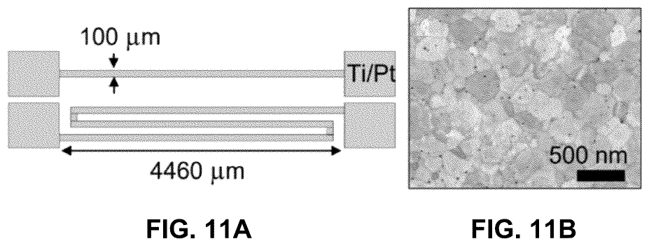

The Ti/Pt traces also showed low sheet resistance, which is notable given the high processing temperatures (750° C.) used for CNT growth. Referring to FIG. 11A, Ti/Pt trace resistance was evaluated using linear resistive test structures formed adjacent to the electrochromic devices described in this Experimental section. Critically, the test structures were exposed to identical processing steps as the real spectroelectrochemical devices created. The resulting sheet resistance is ˜1.4 Ω·sq⁻¹. The Ti and Pt layers are 20 and 160 nm thick, respectively. FIG. 11B is a SEM image of the Ti/Pt trace after complete processing of the films (including CNT growth), which shows that the Pt grains are equiaxed, continuous, and span between 100 and 500 nm on a side.

Cyclic voltammetry (CV; FIG. 4F) reveals a capacitor-like response with differential capacitance values in the range of 500 μF, as expected for these large surface area electrodes. Complementary through-plane conductance traces acquired during CV scans show ambipolar transport characteristics (FIG. 4E) and verify that carriers are indeed being injected into the CNTs.

In CV scans, the conductance minimum occurs at the CNT half filling potential, which is referred to as Vhf. Because the reaction occurring at the reference electrode is not well defined, Vhf can shift arbitrarily over the course of several days.

FIG. 5A shows the infrared response of an electrochemically gated VACNT film. Spectra were collected at V_{WE} between ±1.0 V (relative to the reference electrode), applying a constant potential for ˜120 seconds before each measurement to ensure full charging of the CNTs. The broad, prominent peak is assigned to the intersubband plasmon absorption.

FIG. 5B illustrates ISBP peak energy versus V_{WE} extracted from data in FIG. 5A. FIG. 5C is a log of the CNT film conductance measured simultaneously to the optical measurements. That conductance minimum corresponds to the half-filling potential V_{hf}. For this particular film, V_{hf}=0.12 V. The VACNT film in this device was 1.5 micron thick with d_{CNT}=2.6±0.7 nm (Type 1 catalyst).

When V_{WE} is set near the conductance minimum (V_{hf}; see FIG. 5C) the device produces a featureless extinction spectrum that does not contain any interband absorption peaks, which for 2.6 nm CNTs appear at 0.28 (E11), 0.55 (E22), and 0.83 eV (M11). The lack of observable interband transitions is due to anisotropic optical absorption by CNTs; interband transitions are strongly suppressed in these films (on account of the depolarization effect) for light polarized perpendicular to the CNT axis.

The high degree of vertical alignment present in the films means that normally-incident light is polarized perpendicular to the CNT axis and therefore does not strongly excite interband optical transitions that lie in the near infrared.

Electrochemical gating in the range of ±0.3 V vs. Vhf yields no measurable change in the infrared absorption spectra. As V_{WE} is reduced below −0.3 V or increased above 0.4 V, a prominent ISBP absorption peak appears. The peak is first visible around 0.4 eV and, with larger potentials, both intensifies and blue shifts up to 0.7 eV. FIGS. 5B and 5C capture the ISBP energy and CNT conductance as a function of VwE. From these data it is seen that the ISBP energy shifts in proportion with the CNT conductance, which itself is proportional to the free-carrier concentration within the CNT films. Strong correlation of the intensity and energy of the observed absorption peak with the CNT film conductance allows us to unambiguously assign the peak as being an ISBP absorption feature. Notably, the ISBP absorption peak rises far above the baseline produced by interband absorption in the un-gated CNT film. This contrasts with previous reports of ISBP absorption (which show relatively small ISBP absorption features) and is due to the high degree of vertical CNT alignment in the films. It is also interesting to note that the baseline spectrum of undoped VACNT films do not exhibit any clear interband absorption peaks, which may be associated with a broad CNT diameter dispersion but is again due to the vertical CNT alignment present in these films.

Finally, the viability of these VACNT films as near-infrared electrochromic materials was evaluated. To do so, key performance metrics relevant for electrochromic devices or electro-optic modulators were evaluated, including insertion loss, modulation depth, switching rates, and volatility.

FIG. 12 shows energy-dependent insertion loss and modulation depth for three VACNT film thicknesses. A transmittance of 1 is transparent, while a transmittance of 0 is opaque. These values are not corrected for reflection losses at the sapphire/air interfaces.

Referring again to FIG. 6A, the transient optical and electrical responses at λ˜1630 nm upon cycling the device between the “off” and “on” states (E_{WE}=0.0 and 1.0 V, respectively). The characteristic on and off times were 6 and 1 seconds, respectively. Observed were t₉₀ times (the time it takes to reach 90% of the steady state transmittance) in the range of one to ten seconds, which is dominated by the large device capacitance (˜500 μF) and relatively high sheet resistance of the CNT films. Using capacitance and resistance values typical of these films, an RC time constant of 1-10 seconds was calculated. While these response times are relatively slow, scaling down the geometric area of the device is expected to yield a proportional decrease in the switching time. FIG. 6A also shows that the switching speeds are asymmetric (t₉₀, on ˜6 s and t₉₀, off ˜1 s). This asymmetry is attributed to the ˜10× difference in sheet resistance of the CNT film in the doped vs. undoped state.

Another important characteristic of electrochromic materials is their ability to retain an optical state upon removal of the electrical bias. FIG. 6B shows the optoelectronic response during potentiostatic control (V_{WE}) and upon switching to an open-circuit configuration. Interestingly, the device showed very slow discharge rates, maintaining 90% of the initial optical change at 100 seconds. This slow discharge may be further slowed by introducing a physical open-circuit switch rather than the finite (but large) resistance of the potentiostat when it is set to an open-circuit condition. The fast switching rates relative to the slow discharge rates means these materials are viable for passive matrix optical displays which require at least short term non-volatility of the optical state, or for large area windows where bi-stability is more critical than rapid switching speeds.

The use of TiN traces was briefly explored as a way of increasing the electrochemical stability window of the devices and the degree of electrochemical doping. Indeed, it was found that the devices were stable in the range of ˜±2 V and exhibited a change in transmittance at 1700 nm of ˜47% rather than the 24% achieved with Pt traces.

### In Use

The various approaches described herein may be used in any manner that would become apparent to one skilled in the art after reading the present disclosure.

In some approaches, the actuators described herein may be used to construct an electrically addressable radiation modulation screen, e.g., a selectively openable IR radiation barrier.

Devices described herein, according to various approaches, may be fabricated into large-area windows that modulate the flow of infrared radiation into buildings, may be integrated as micro-arrays into optical computing chips to modulate or route the flow of infrared optical communication signals, etc.

For example, exemplary devices may include low-power, large-area, optically-transparent dynamic windows capable of modulating the flow of infrared radiation in and out of buildings. Other exemplary devices include low-power optical switches for optical communication methods that rely on infrared wavelengths.

### Large Stroke Carbon Nanotube Actuators

In a second aspect of the invention, an apparatus includes an actuator capable of large stroke linear or angular actuation. The actuator comprises an aligned carbon nanotube (ACNT) microstructure and at least one electrically conductive electrode in electrical communication with the ACNT microstructure. More detailed information is provided below.

In various approaches, devices use ACNTs to either allow or restrict transmission of visible and/or IR radiation. Carbon nanotubes (CNTs) are used due to their excellent absorption characteristics of IR radiation. Such devices may incorporate ACNT structures that can be actuated to change shape in response to external stimuli and a transparent substrate that the ACNT structures are located on. The substrate may additionally include necessary provisions to deliver such external stimuli to the ACNT structures, such as electrical traces, magnets, electromagnets, compression mechanisms, and/or any other component that would become apparent to one skilled in the art after reading the present disclosure.

In preferred approaches, the ACNT structures are designed to cover as much of the substrate as possible in one state (closed state; blocking transmission of the infrared radiation), and as little as possible in another state (open state; allowing transmission of the infrared radiation).

The ACNT microstructure may include ACNTs that are about 1 nm to about 100 nm in average diameter, while the CNT structures themselves can be several nanometers to several centimeters in width, depth, and height. In the closed state, the ACNT microstructure may cover an area that ranges from several square nanometers to several square centimeters.

As described in much more detail below, there are two preferred operating mechanisms disclosed herein. They are both ACNT microstructure based actuators: 1) one that is capable of large stroke linear actuation, 2) one that is capable of large stroke angular actuation.

For large areas, such ACNT structures and associated components to actuate them may be repeated in an array, e.g., to cover a window or other transparent substrate. The ACNT structures may be addressable together, and/or each individual structure may be addressable independently to allow for local control of the infrared transmission.

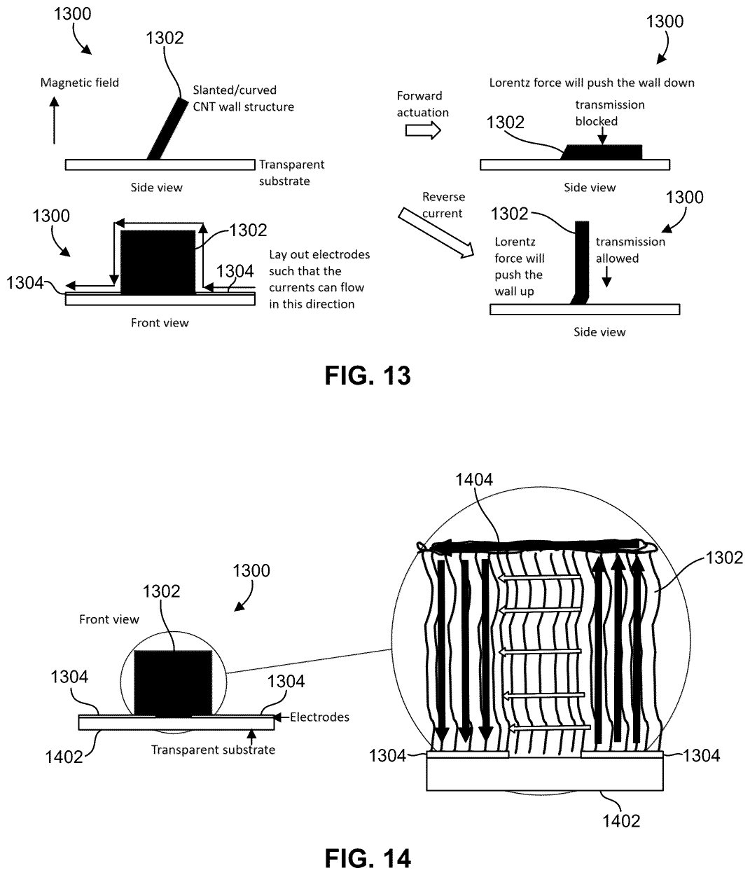

FIG. 13 depicts an exemplary ACNT wall actuator 1300 for electromagnetic radiation transmission modulation, according to one embodiment. As an option, the present device may be implemented in conjunction with features from any other approach listed herein, such as those described with reference to the other Figures. Of course, however, such device and others presented herein may be used in various applications and/or in permutations which may or may not be specifically described in the illustrative approaches listed herein. Further, the device presented herein may be used in any desired environment.

The drawings on the left of FIG. 13 depict a side view and a front view, respectively. In the side view, the ACNT structure 1302 extends from a horizontal transparent substrate in a slanted or curved orientation. The ACNT structure is preferably grown in the slanted or curved orientation directly on the substrate.

In one approach, slanted ACNTs may be formed by growing some of the CNTs faster than others in the same array. As the faster CNTs grow, they push the slower growing CNTs over, causing the CNT forest to grow in a generally diagonal orientation. To cause a differential in growth rate, different seed material may be used in different areas of the substrate, i.e., one area has a seed that causes faster growing CNTs than the seed in another area.

In other approaches, the ACNT structure may be affixed to the substrate in a slanted or curved orientation. As also shown in the side view, a magnetic field may be present, e.g., due to presence of a permanent magnet, electromagnet, etc. As shown in the front view, electrodes 1304 are provided so that current flows across the ACNT structure generally following the direction of the arrows. More description of the electrodes is presented below with reference to FIG. 14. Current flow through the ACNTs between the electrodes creates a magnetic field around the ACNTs according to the “right hand rule.” This field cooperates with the aforementioned magnetic field to open or close the ACNT array, in dependence on which direction the current is flowing, and thus which direction the field from the current is oriented.

When the current is applied in a manner that causes forward actuation, exemplified by the drawing in the upper right, Lorentz Force pushes the ACNT structure down, which blocks transmission of infrared and/or visible light through the portion of the substrate there under. When the current is reversed, as exemplified by the drawing in the lower right, the resulting Lorentz force pushes the wall up toward an open state, allowing maximum transmission of incoming infrared and/or visible light through the substrate (assuming the infrared light is incoming in a direction orthogonal to the plane of the substrate).

FIG. 14 provides an example of how current flows through the ACNT structure 1302. As shown in the front view on the left side, the illustrative device 1300 includes a transparent substrate 1402, electrodes 1304, and an ACNT structure 1302 extending from the substrate, e.g., in a slanted manner as shown in FIG. 13. As an option, the present device 1300 may be implemented in conjunction with features from any other approach listed herein, such as those described with reference to the other Figures. Of course, however, such device and others presented herein may be used in various applications and/or in permutations which may or may not be specifically described in the illustrative approaches listed herein. Further, the device presented herein may be used in any desired environment.

Looking next to the drawing on the right side of FIG. 14, assume current is flowing from the right electrode to the left electrode. The current will first flow up the length of the ACNTs, meet the tangled crust layer on top 1404, and then travel laterally before travelling down the ACNTs and flowing out of left electrode. This is not to say current flow perpendicular to parallel ACNTs will not occur, but that the conductivity in the perpendicular direction is a fraction of that along the length (˜⅓). The lateral current flow will generate a Lorentz force. The dominant current flow path is shown with thicker arrows and less dominant ones in thinner arrows below. Note the linear arrows overlying the slightly wavy ACNTs in the middle.

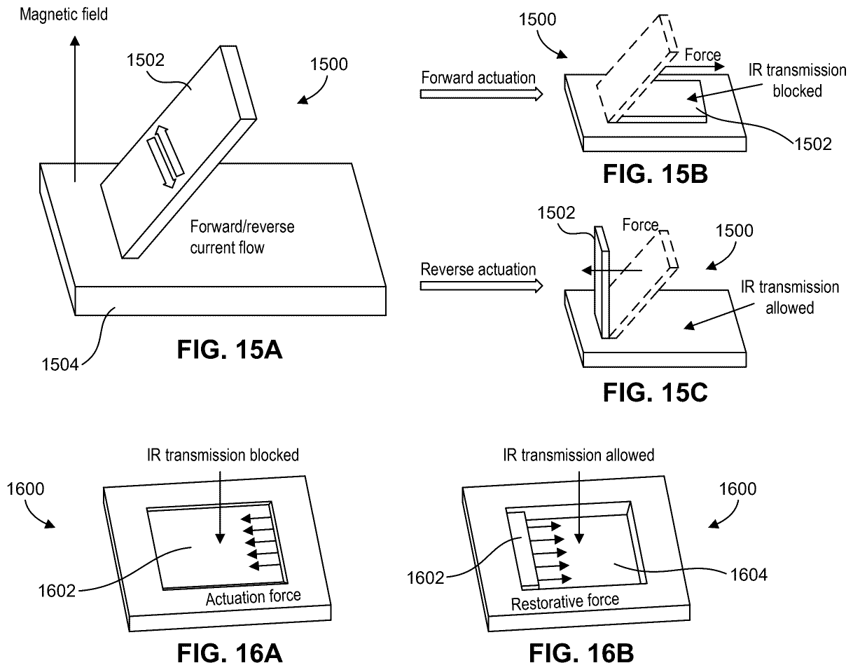

FIGS. 15A-15C depict a large stroke ACNT-based angular actuator 1500 acting as a “blind.” As an option, the present device may be implemented in conjunction with features from any other approach listed herein, such as those described with reference to the other Figures. Of course, however, such device and others presented herein may be used in various applications and/or in permutations which may or may not be specifically described in the illustrative approaches listed herein. Further, the device presented herein may be used in any desired environment.

FIG. 15A illustrates how the ACNT structure 1502 is grown in a slanted orientation relative to the substrate 1504, and is configured for angular actuation. Depending on the direction of the actuation force, the ACNT structure can become parallel or perpendicular to the substrate. In FIG. 15B, the ACNT structure is parallel to the substrate and is in the “closed state.” In FIG. 15C, the ACNT structure is perpendicular to the substrate and is in the “open state.”

The apparatus 1500 described immediately below is analogous to a “blind” where opaque planar objects are rotated to either decrease (FIG. 15C, “open state”) or increase (FIG. 15B, “closed state”) their footprint in the path of the incoming infrared radiation. The ACNT structure may be grown in a slanted orientation from the substrate (as shown in FIG. 15A, between horizontal and vertical), and depending on the direction of the actuation force, can be rotated to be perpendicular (“open state”) to the substrate or parallel (“closed state”) to the substrate. The nature of the force may be electrostatic, electro-mechanical, magneto-mechanical, electro-magnetic and/or any other force that can be induced at this scale. The ACNT structures may be coated with one or more other materials to improve their mechanical/electrical/magnetic/optical properties, if desired.

In some embodiments, the ACNT structures are configured for linear actuation. FIGS. 16A-16B depict a large stroke ACNT-based linear actuator 1600 acting as a “curtain.” As an option, the present device 1600 may be implemented in conjunction with features from any other approach listed herein, such as those described with reference to the other Figures. Of course, however, such device and others presented herein may be used in various applications and/or in permutations which may or may not be specifically described in the illustrative approaches listed herein. Further, the device presented herein may be used in any desired environment.

In FIG. 16A the ACNT structure 1602 is fully extended in the absence of actuating force and is in the “closed state.” In FIG. 16B, the ACNT structure is compacted near the base when the actuating force is in effect and is in the “open state.”

This approach is conceptually analogous to a “curtain” that can be drawn to a “closed state” to block out sunlight, or be bunched up toward one side to be in an “open state” where the sunlight can pass through and illuminate the room. CNTs provide good absorption across particular and/or wide ranges of light wavelengths, e.g., UV, visible, and IR. Accordingly, CNTs may be selected based on their absorptive capabilities and the intended use. The diameters and lengths of the ACNTs may be selected based on the desired application. For example, average axial lengths of the ACNTs may be in the range of sub-micron lengths to several centimeters, e.g., <1 micron to about 5 centimeters, more preferably in a range of about 10 nanometers up to about 1 centimeter. Preferably, the ACNTs have an aspect ratio of at least 5:1 (length: diameter), though smaller ratios may be used in some applications.

The ACNT structure may be grown horizontally within an opening 1604 in the substrate, as shown below, or grown elsewhere and coupled thereto, and nominally be in the “closed state.” Upon application of a force acting on the top of the ACNT structure in the direction from the top toward the bottom of the ACNT structure, as shown in FIG. 16A, the ACNTs becomes compressed, toward the bottom, opening the window, as shown in FIG. 16B. The nature of the force may be electrostatic, electro-mechanical, magnetomechanical, electro-magnetic and/or any other force that can be induced at this scale.

The force acting on the top of the ACNT structure should be strong enough to compress the structure elastically, “packing” it toward its base, resulting in the “open state” shown in FIG. 16B. Once the actuating force is removed, the elastic energy stored in the ACNTs restore the ACNT structure to the fully extended “closed state.”

The ACNT structures may be coated/topped with other materials to improve their mechanical, electrical, magnetic, and/or optical properties if desired. For example, a coating of iron may be applied to the tops of the ACNTs in FIG. 16A, and used in conjunction with an electromagnet to compress the ACNTs toward the bottom.

In another approach, a member may physically push the ACNTs toward the open state.

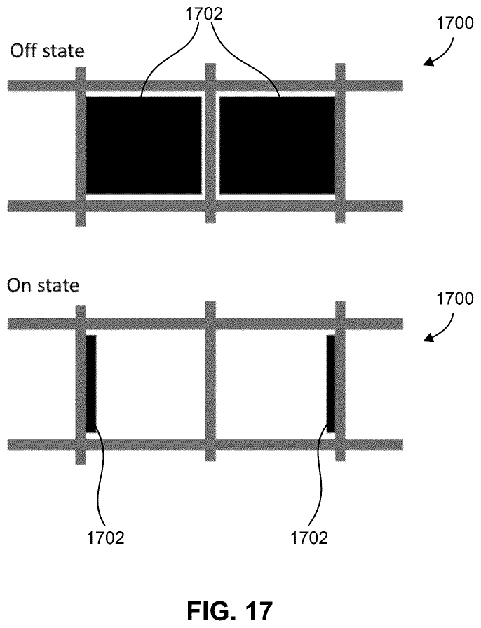

FIG. 17 depicts a top-down view of an array 1700 of linear-actuating ACNT structures 1702 as viewed from a vantage point orthogonal to the underlying substrate. As an option, the present device may be implemented in conjunction with features from any other approach listed herein, such as those described with reference to the other Figures. Of course, however, such device and others presented herein may be used in various applications and/or in permutations which may or may not be specifically described in the illustrative approaches listed herein. Further, the device presented herein may be used in any desired environment.

As exemplified by FIG. 17, the array 1700 of ACNT structures 1702 may act as curtains. Moreover, ACNT structures in such arrays may be independently controllable, e.g., to act as pixels that allow local modulation of how much light to allow through a window.

Large stroke linear actuators utilizing compression and recovery of ACNTs has not been reported yet. Likewise, large stroke angular actuators utilizing the non-vertical growth of ACNTs and their mechanical resilience has not been demonstrated.

### In Use

The various aspects and approaches described herein may be used in any manner that would become apparent to one skilled in the art after reading the present disclosure.

Devices described herein, according to various approaches, may be fabricated into small-or large-area windows that modulate the flow of infrared radiation into and out of buildings, may be integrated as micro-arrays into optical computing chips to modulate or route the flow of infrared optical communication signals, etc. Furthermore, this device design also proves useful for modulating the propagation or emission of mid or far-infrared electromagnetic radiation.

### Conclusion

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. An electrochromic device, comprising:
a substrate;
an optically-active working electrode coupled to the substrate, the optically-active working electrode having aligned carbon nanotubes (ACNTs);
a counter electrode; and
an electrolyte positioned between the working electrode and the counter electrode.

2. The electrochromic device of claim 1, wherein the ACNTs are vertically-aligned relative to a plane of the substrate.

3. The electrochromic device of claim 1, wherein the ACNTs are grown on the substrate.

4. The electrochromic device of claim 1, wherein the substrate is optically transparent and/or infrared transparent.

5. The electrochromic device of claim 1, wherein the substrate is optically opaque and/or infrared opaque.

6. The electrochromic device of claim 1, wherein the electrolyte infills interstices between the ACNTs of the working electrode.

7. The electrochromic device of claim 1, wherein the counter electrode includes second ACNTs.

8. The electrochromic device of claim 1, comprising a control circuit configured to control a voltage and/or level of current applied to the electrodes to adjust optical properties of the ACNTs in a predefined manner.

9. The electrochromic device of claim 1, comprising a second substrate facing the optically-active working electrode, wherein the counter electrode is positioned on the second substrate.

10. The electrochromic device of claim 9, wherein the counter electrode includes second ACNTs positioned between the substrate and the second substrate.

11. The electrochromic device of claim 9, wherein the substrate and the second substrate are coupled together to enclose the electrolyte therebetween.

12. An electrochromic device, comprising:
a porous membrane;
an optically-active working electrode coupled to a first side of the membrane, the working electrode having aligned carbon nanotubes (ACNTs);
a counter electrode coupled to a second side of the membrane that is positioned on an opposite side of the membrane as the first side; and
an electrolyte positioned between the working electrode and the counter electrode.

13. The electrochromic device of claim 12, wherein the ACNTs are vertically-aligned relative to a plane of the membrane.

14. The electrochromic device of claim 12, wherein the electrolyte infills interstices between the ACNTs of the working electrode.

15. The electrochromic device of claim 12, wherein the counter electrode includes second ACNTs.

16. The electrochromic device of claim 12, comprising a control circuit configured to control a voltage and/or level of current applied to the electrodes to adjust optical properties of the ACNTs in a predefined manner.

17. An apparatus, comprising:
at least one electrochromic device comprising an optically-active region having aligned carbon nanotubes (ACNTs), a counter electrode, and an electrolyte positioned between the optically-active region and the counter electrode; and
electrical traces configured to enable addressing the at least one electrochromic device for activating individually-addressable pixels of the apparatus.

18. The apparatus of claim 17, wherein the optically-active region of the at least one electrochromic device is subdivided into the individually-addressable pixels.

19. The apparatus of claim 18, wherein the individually-addressable pixels have lateral dimensions along one side thereof in a range of about 100 nm to about 500 nm.

20. The apparatus of claim 17, wherein a plurality of the electrochromic devices are assembled into an array, each of the electrochromic devices providing at least one of the individually-addressable pixels.
